(19) United States
(12) Patent Application Publication
(10) Pub. No.: US 2009/0071571 A1
(43) Pub. Date: Mar. 19, 2009

(54) Power tool table

(76) Inventor: Richard D. Huber, Danville, CA (US)

Correspondence Address: PETER JAMES TORMEY, 2017 ESPERANZA DRIVE, CONCORD, CA, 94519, US

(21) Appl. No.: 11/901,325

(22) Filed: Sep. 17, 2007

(51) Int. Cl. B25H 1/02

(52) U.S. Cl. 144/286.1

(57) ABSTRACT

A folding table comprising a substantially planar surface, said surface having an elongated slot disposed through the planar surface for receiving a cutting edge of a hand-operated power tool; said planar surface supported by at least two front vertical members interconnected by at least one cross member, and at least two rear vertical members interconnected by at least one cross member; at least two side cross-members interconnecting the front and rear vertical members, said side cross-members hinged to allow for folding the table; and a tool carriage coupled to a lever said lever connected to a foot pedal such that depressing the foot pedal raises or lowers the tool carriage, wherein a hand-operated power tool is mounted in the tool carriage such that the lever moves the tool carriage towards the planer surface extending the cutting edge through the elongated slot in the planar surface.

### BACKGROUND

The present invention relates generally to portable worktables and more particularly to a folding worktable with a power tool mounted below the table surface.

Mobile workers are required to carry all the requisite tools to a job site in order to complete the job. For construction workers, this often requires carrying numerous powered hand tools and, on occasion, larger and heavier tools such as table saws. The larger, heavier tools entail additional labor for both transport and setup. Having numerous expensive tools on-site places the worker at risk of theft or other loss of his tools from the job site or from the work vehicle. A portable table is needed which operates as a workbench by allowing numerous and varied powered hand tools to be operated from or on it.

### SUMMARY

Disclosed herein is a folding portable table comprising a substantially planar surface, said surface having a top face and a bottom face and an elongated slot disposed through the planar surface for receiving a cutting edge of a hand-operated power tool; said planar surface to be supported by at least two front vertical members interconnected by at least one cross member, and at least two rear vertical members interconnected by at least one cross member; at least two side cross-members interconnecting the front and rear vertical members, said side cross-members hinged to allow for folding the table and a tool carriage coupled to a lever such that the tool carriage moves towards, or away from, the planar surface controlled by the lever, said lever connected to a foot pedal such that depressing the foot pedal raises or lowers the tool carriage; an electrical switch disposed on the table for coupling electricity to the hand-operated power tool depending on the position of the switch; a fastener for locking a power switch on the hand-operated tool into the “on” position, wherein a hand-operated power tool is mounted in the tool carriage such that the cutting edge of the tool is disposed towards the slot and the lever moves the tool carriage towards the planer surface and which extends the cutting edge through the elongated slot in the planar surface.

The construction and method of operation of the invention, however, together with its additional objectives and advantages, will be best understood when the following description of specific embodiments is read with the accompanying drawings present and in full view.

### BRIEF DESCRIPTION OF THE DRAWINGS

FIG. 1 illustrates a perspective view of one embodiment according to the current disclosure.

FIG. 2 illustrates a side view of one embodiment according to the current disclosure using a hand-operated reciprocating saw.

FIG. 3 illustrates a side view of one embodiment according to the current disclosure showing a reciprocating saw in an elevated position.

FIG. 4 illustrates a side view of one embodiment according to the current disclosure showing a reciprocating saw in an elevated position and having vertical supports connected to the table-top.

### DESCRIPTION

Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not, in itself, dictate a relationship between the various embodiments and/or configurations discussed.

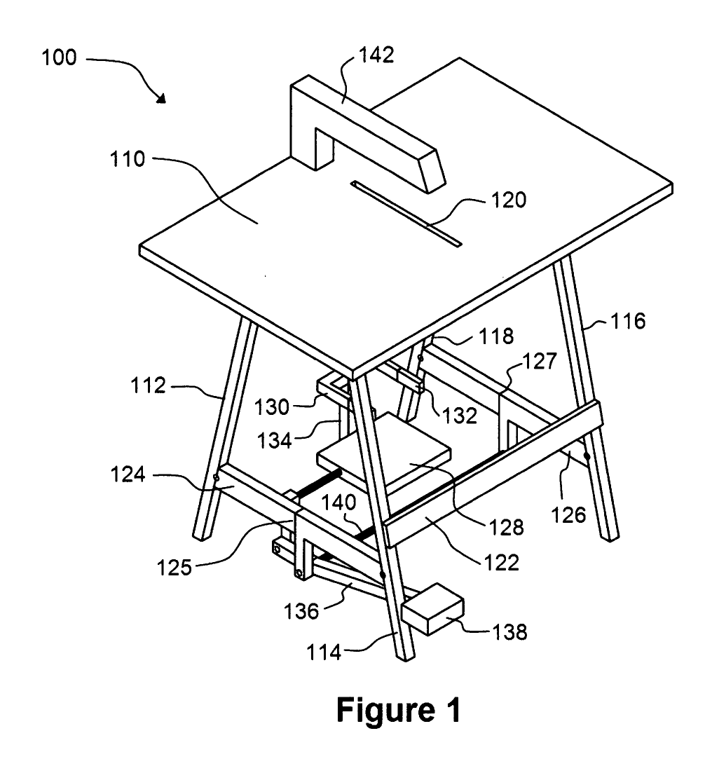

FIG. 1 illustrates a perspective view of one embodiment according to the current disclosure. In FIG. 1 a substantially flat planar surface or table top 110 is supported by four legs or vertical members (112 through 118). The left side legs 112 and 114 are pivotably connected to an articulated cross member 124. A hinge assembly 125 in the articulated cross member 124 allows the legs 112 and 114 to be brought closer together. The right side legs 116 and 118 are pivotably connected to an articulated cross member 126. A hinge assembly 127 in the articulated cross member 126 allows the legs 116 and 118 to be brought closer together.

A tool carriage comprised of a tool base 128, a vertical support 134 and articulated locking arms 130 and 132 is coupled to a lever 136 such that the tool carriage can be raised, or lowered, depending on the position of lever 136. The tool carriage provides for receiving a portable power tool (not shown) and securing it in to the carriage using the articulated locking arms 130 and 132. The locking arms 130 and 132 are fastened with a fastener (not shown). This disclosure allows for a power tool disposed in the tool carriage to be raised towards the table top 110 by the action of lever 136. The power tool's operating edge, for example a saw blade, will then extend through a slot 120 in the table 110 and enable the user to cut on the table.

In the FIG. 1 a foot pedal 138 is connected to level 136 for control of the tool carriage. The lever 136 is pivotably mounted to a cross member 140 which in turn is connected to the cross-members 125 and 126. One having skill in the art will appreciate that a variety of tools with cutting edges may be mounted in the tool carriage such that numerous common power tools may be used with the current embodiment. Note also that the lever action may be designed to accomplish identical results when using any of the available locations for the pivot point and the foot pedal 138. Note also that the cutting guard 142 and slot 120 may be positioned at any of the available places on the table top 110 to effectuate any of the available types of cutting surfaces.

The current embodiment allows for a variety of types of hand-operated power tools to be mounted in the tool carriage. The design which allows a variety of tools to be used with the power tool table eliminates or reduces the need for mobile workers to carry multiple tables for one need or for specific needs lightens the burden on the worker while also saving each worker the significant monetary outlays associated with purchasing, transporting, and setting up multiple tables. Another advantage of the current disclosure is ease-of-use when cutting through materials of various thicknesses because the extension of a cutting blade can be controlled dynamically by the user while performing the operation.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Note also that such phrases do not necessarily refer to the same embodiment. Further, when a particular feature, structure, or characteristic is described in connection with an embodiment, it is submitted that it is within the knowledge of one of ordinary skill in the art to effect such feature, structure or characteristic in connection with other embodiments whether or not such other embodiments are explicitly described. Parts of the description are presented using terminology commonly employed by those of ordinary skill in the art to convey the substance of their work to others who are, likewise, of ordinary skill in the art.

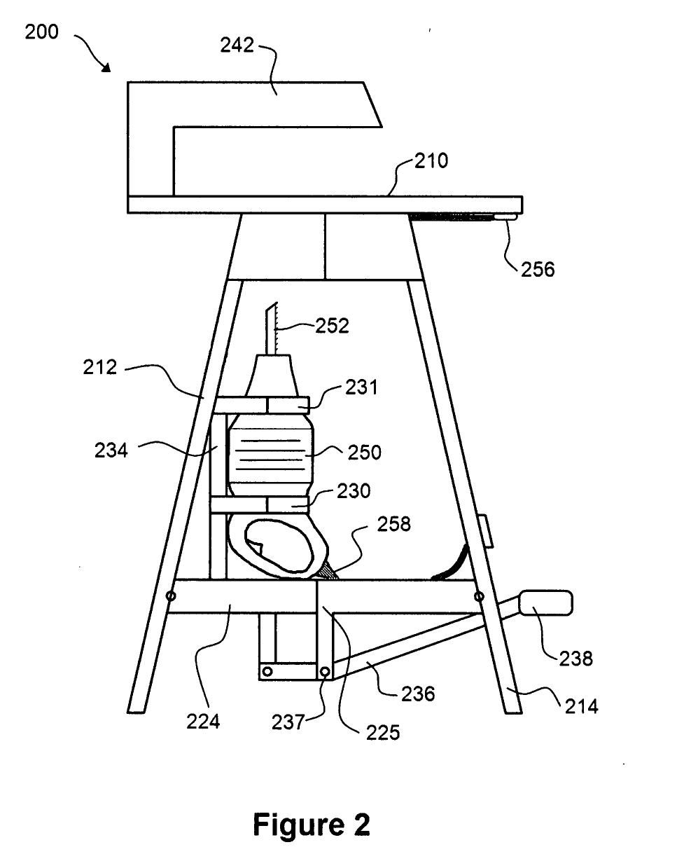

FIG. 2 illustrates a side view of one embodiment according to the current disclosure using a hand-operated reciprocating saw. In the FIG. 2, a hand-operated reciprocating power saw 250 is mounted in the tool carriage such that an upper arm 231 and a lower arm 230 secure the reciprocating saw in place. In the FIG. 2 a substantially flat surface or table top 210 is supported by four legs or vertical members (212 and 214). The left-side legs 212 and 214 are pivotably connected to an articulated cross member 224. A hinge assembly 225 in the articulated cross-member 224 allows the legs 212 and 214 to be brought closer together.

A tool carriage comprised of a tool base (not shown), a vertical support 234 and articulated locking arms 230 and 231 is coupled to a lever 236 such that the tool carriage can be raised or lower depending on the position of lever 236. The tool carriage provides for receiving a portable power tool 250 such as a reciprocating saw and securing it to the tool carriage using the articulated locking arms 230 and 231. The locking arms 230 and 231 are fastened with a fastener (not shown). This disclosure allows for a power tool disposed in the tool carriage to be raised towards the table 210 by the action of lever 236. The power tool's operating edge, for example, saw blade 252 will then extend through a slot (not shown) in the table 210 allowing the user to secure the saw in place while operating the tool. The lever 236 is further attached to a foot pedal 238 allowing a user to raise and lower the tool carriage while working at the table.

A power switch 256 is connected to the table 210 and disposed along the underside such that a user can reach it will standing at the table. A power cord from the power tool 258 connects to the power switch 256, said power switch 256 being further connected to an electrical outlet for providing power to the switch.

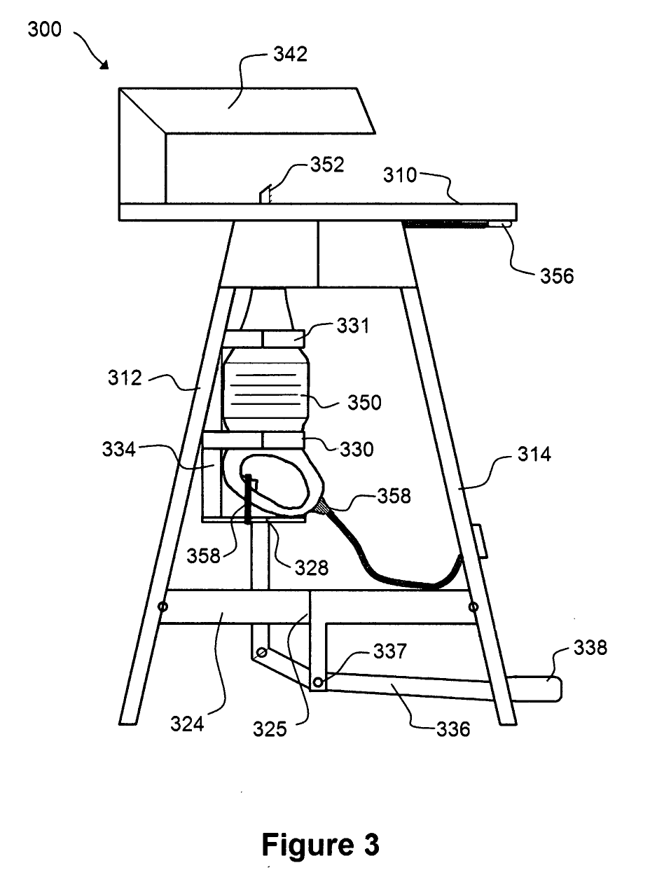

FIG. 3 illustrates a side view of one embodiment according to the current disclosure showing a reciprocating saw in an elevated position. In the figure, a hand-operated reciprocating power saw 350 is mounted in the tool carriage such that an upper arm 331 and a lower arm 330 secure the reciprocating saw in place. In the figure a substantially flat surface or table top 310 is supported by four legs or vertical members (312 and 314). The left side legs 312 and 314 are pivotably connected to an articulated cross member 324. A hinge assembly 325 in the articulated cross member 324 allows the legs 312 and 314 to be brought closer together.

A tool carriage comprised of a tool base 328, a vertical support 334 and articulated locking arms 330 and 331 is coupled to a lever 336 such that the tool carriage can be raised or lower depending on the position of lever 336. The tool carriage provides for receiving a portable power tool 350 such as a reciprocating saw and securing it in to the tool carriage using the articulated locking arms 330 and 331. The locking arms 330 and 331 are fastened with a fastener (not shown). This disclosure allows for a power tool disposed in the tool carriage to be raised towards the table 310 by the action of lever 336. The power tool's operating edge, for example, saw blade 352 will then extend through a slot in the table top 310 as shown, thus allowing a user to secure the saw in place while operating the tool. The lever 336 is further attached to a foot pedal 338 allowing a user to raise and lower the tool carriage while working at the table.

A power switch 356 is connected to the table top 310 and disposed along the underside such that a user can reach it will standing at the table. A power cord from the power tool 358 connects to the power switch 356, said power switch 356 being further connected to an electrical outlet for providing power to the switch. In this embodiment a fastener such as a strap or clamp 358 is attached over the operation switch of the reciprocating saw 350 to hold the trigger of the reciprocating saw in the “on” position. This allows for the power tool to be operated by power switch 356 even though the power tool 350 may not have a locking trigger mechanism. It also provides a means for control of the power tool while the operator stands at the table. Note also that a lever locking mechanism (not shown) may be employed to hold the lever in place during operation.

One having skill in the art will appreciate that many differing type of hand-operated power tools may be mounted to the table described above. The tool carriage may be constructed to accommodate a variety of shaped tools from numerous manufacturers.

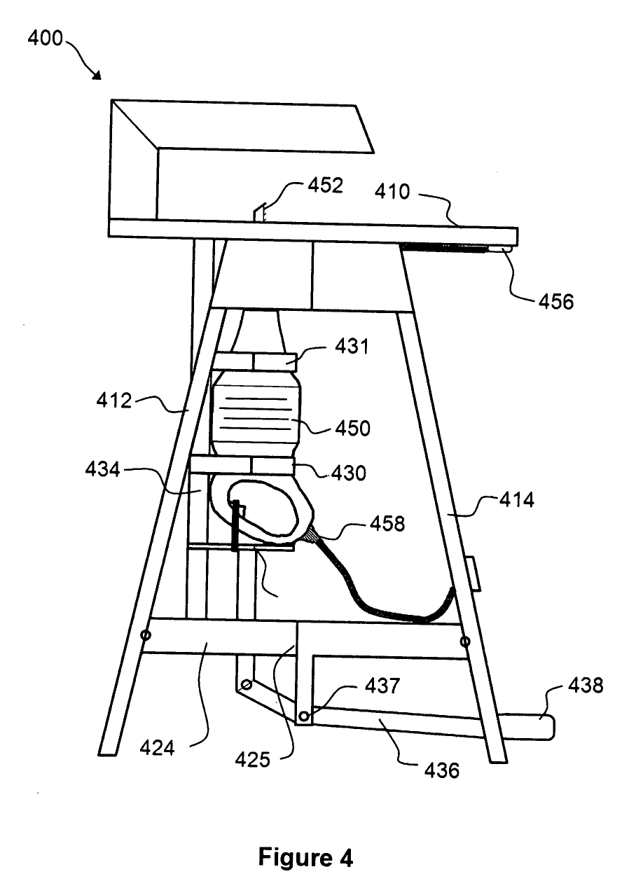

FIG. 4 illustrates a side view of one embodiment according to the current disclosure showing a reciprocating saw in an elevated position and having vertical supports connected to the table top. In the FIG. 4, a hand-operated reciprocating power saw 450 is mounted in the tool carriage such that an upper arm 431 and a lower arm 430 secure the reciprocating saw in place. In the FIG. 4 a substantially flat surface or table top 410 is supported by four legs or vertical members (412 and 414). The left side legs 412 and 414 are pivotably connected to an articulated cross member 424. A hinge assembly 425 in the articulated cross member 424 allows the legs 412 and 414 to be brought closer together.

A tool carriage comprised of a tool base 428, a vertical support 434 and articulated locking arms 430 and 431 is coupled to a lever 436 such that the tool carriage can be raised or lower depending on the position of lever 436. In this embodiment the tool carriage is slidably coupled to the vertical support 434 such that the tool carriage is guided towards the table top 410, the vertical support 434 being connected to the table top 410 and to a support member (not shown). The tool carriage provides for the reception of a portable power tool 450 such as a reciprocating saw and securing it in to the tool carriage using the articulated locking arms 430 and 431. The locking arms 430 and 431 are fastened with a fastener (not shown). This disclosure allows for a power tool disposed in the tool carriage to be raised towards the table 410 by the action of lever 436. The power tool's operating edge, for example, saw blade 452 will then extend through a slot in the table top 410 as shown, thereby allowing a user to secure the saw in place while operating the tool. The lever 436 is further attached to a foot pedal 438 allowing an operator to raise and/or lower the tool carriage while working at the table.

A power switch 456 is connected to the table top 410 and disposed along the underside such that a user can reach it will standing at the table. A power cord from the power tool 458 connects to the power switch 456, said power switch 456 being further connected to an electrical outlet for providing power to the switch. A strap 458 is attached over the operation switch of the reciprocating saw 450 to hold the trigger of the reciprocating saw in the on position. This allows for the power tool to be operated by power switch 456 even though the power tool 450 may not have a locking trigger mechanism thus providing for control of the power tool while standing at the table. Also a lever locking mechanism (not shown) may be employed to hold the lever in place during operation.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A folding table comprising:
a substantially planar surface, said surface having a top face and a bottom face and an elongated slot disposed through the planar surface for receiving a cutting edge of a tool;
said planar surface supported by at least two front vertical members interconnected by at least one cross member, and at least two rear vertical members interconnected by at least one cross member;
at least two side cross-members interconnecting the front and rear vertical members, said side cross-members hinged to allow the table to be folded; and
a tool carriage coupled to a lever such that the tool carriage moves towards or away from the planar surface controlled by the lever,
wherein a hand-operated power tool is mounted in the tool carriage such that the operating edge of the tool is disposed towards the slot and the lever moves the tool carriage towards the planer surface extending the operating edge through the elongated slot.

2. The table of claim 1 further comprising:
a pedal connected to the lever such that a user controls the position of the tool carriage using the pedal.

3. The table of claim 1 further wherein the tool carriage is slidably coupled to one or more vertical structures connected to the planar surface.

4. The table of claim 1 wherein the hand-operated power tool is a reciprocating saw and the operating edge is a saw blade.

5. The table of claim 1 further comprising:
a fastener connected to the tool carriage,
wherein the fastener locks the trigger of the hand-operated power tool.

6. The table of claim 1 further comprising:
an electrical switch for receiving operating power and providing it to the hand-operated power tool when the switch is closed.

7. The table of claim 6 wherein the electrical switch is connected to the planar surface.

8. The table of claim 6 wherein the electrical switch is connected to the table such that depressing the pedal activates the switch.

9. A folding table comprising:
a substantially planar surface, said surface having a top face and a bottom face and an elongated slot disposed through the planar surface for receiving a cutting edge of a hand-operated power tool;
said planar surface supported by at least two front vertical members interconnected by at least one cross member, and at least two rear vertical members interconnected by at least one cross member;
at least two side cross-members interconnecting the front and rear vertical members, said side cross-members hinged to allow for folding the table; and
a tool carriage coupled to a lever such that the tool carriage moves towards or away from the planar surface controlled by the lever, said lever connected to a foot pedal such that depressing the foot pedal raises or lowers the tool carriage;
an electrical switch disposed on the table for coupling electricity to the hand-operated power tool depending on the position of the switch;
a fastener for locking a power switch on the hand-operated tool into the on position,
wherein a hand-operated power tool is mounted in the tool carriage such that the cutting edge of the tool is disposed towards the slot and the lever moves the tool carriage towards the planer surface extending the cutting edge through the elongated slot in the planar surface.

10. The table of claim 9 wherein the electrical switch is connected to the planar surface.

11. The table of claim 9 wherein the electrical switch is connected to a vertical member such that depressing the pedal activates the switch.

12. The table of claim 9 further comprising:
at least one vertical support member connected to the planar surface such that the tool carriage is slidably coupled to the at least one vertical support member,
wherein the at least one vertical support member provides increased stability while the tool carriage moves.

13. A folding worktable comprising:
a horizontal slot disposed in a top planar surface;
a tool carriage coupled to a lever, said tool carriage for receiving a hand-operated reciprocating saw;
wherein the lever raises the tool carriage such that a cutting blade of the reciprocating saw extends through the slot disposed in the top planar surface.

14. The worktable of claim 13 further comprising:
an electrical switch for receiving operating power and providing it to the reciprocating saw when the switch is closed, and
a fastener for securing the operating switch of the reciprocating saw in the on position.

15. The worktable of claim 14 wherein the tool carriage is interchangeable to allow for receiving reciprocating saws of differing designs.
